(19) United States
(12) Patent Application Publication
(10) Pub. No.: US 2022/0044698 A1
(43) Pub. Date: Feb. 10, 2022

(54) ACOUSTIC EVENT DETECTION SYSTEM AND METHOD

(71) Applicant: REALTEK SEMICONDUCTOR CORP., Hsinchu (TW)

(72) Inventor: HUNG-PIN HUANG, HSINCHU (TW)

(21) Appl. No.: 17/356,696

(22) Filed: Jun. 24, 2021

(30) Foreign Application Priority Data
Aug. 4, 2020 (TW) 109126269

(51) Int. Cl. G10L 25/78; G10L 25/51; G10L 25/27; G10L 25/24; G10L 21/0224; G06N 20/00

(52) U.S. Cl. CPC G10L 25/78; G10L 25/51; G06N 20/00; G10L 25/24; G10L 21/0224; G10L 25/27

(57) ABSTRACT

An acoustic event detection system and a method are provided. The system includes a voice activity detection subsystem, a database, and an acoustic event detection subsystem. The voice activity detection subsystem includes a voice receiving module, a feature extraction module, and a first determination module. The voice receiving module receives an original sound signal, the feature extraction module extracts a plurality of features from the original sound signal, and the first determination module executes a first classification process to determine whether or not the plurality of features match to a start-up voice. The acoustic event detection subsystem includes a second determination module and a function response module. The second determination module executes a second classification process to determine whether the features match to at least one of a plurality of predetermined voices. The function response module executes one of functions corresponding to the predetermined voices that is matched.

### CROSS-REFERENCE TO RELATED PATENT APPLICATION

This application claims the benefit of priority to Taiwan Patent Application No. 109126269, filed on Aug. 4, 2020. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an acoustic event detection system and method, and more particularly to an acoustic event detection system and method that can save storage space and computing power consumption.

### BACKGROUND OF THE DISCLOSURE

Existing audio wake-up applications are mostly used to detect certain “events”, such as voice commands or acoustic events (cries, shattering glass, etc.), and trigger response actions, such as sending a command data to the cloud or issuing an alarm signal.

The audio wake-up applications are mostly implemented with an “always-on” system. In other words, a detection system always “monitors” ambient sound and collects required voice signals. A system that is always activated consumes a lot of power. In order to effectively control power consumption, most devices use a voice activity detection (VAD) to filter away most invalid sound signals to avoid entering into an acoustic event detection (AED) stage for an excessive number or length of times, which requires a lot of computing resources.

In existing VAD and AED stages, each has two main parts: a feature extraction and an identifier. The system first uses the VAD to detect voice, if the voice is active, the system sends the voice signal to an acoustic event recognition/detection module. However, in the above-mentioned VAD and AED stages, power consumption of the feature extraction becomes very important.

Therefore, improving the above-mentioned voice detection mechanism has become one of the important issues in the art.

### SUMMARY OF THE DISCLOSURE

In response to the above-referenced technical inadequacies, the present disclosure provides an acoustic event detection system and method, and more particularly to an acoustic event detection system and method that can save storage space and computing power consumption.

In one aspect, the present disclosure provides an acoustic event detection system, which includes a voice activity detection subsystem, a database, and an acoustic event detection subsystem. The voice activity detection subsystem includes a voice receiving module, a feature extraction module, and a first determination module. The voice receiving module is configured to receive an original sound signal, the feature extraction module is configured to extract a plurality of features from the original sound signal, and the first determination module is configured to execute a first classification process to determine whether or not the plurality of features match to a start-up voice. The database is configured to store the extracted features. The acoustic event detection subsystem includes a second determination module and a function response module. The second determination module is configured to, in response to the first determination module determining that the plurality of features match the start-up voice, execute a second classification process to determine whether or not the plurality of features match to at least one of a plurality of predetermined voices. The function response module is configured to, in response to the second determination module determining that the plurality of features match at least one of the plurality of predetermined voices, execute one of a plurality of functions corresponding to the at least one of the plurality of predetermined voices that is matched.

In another aspect, the present disclosure provides an acoustic event detection method including: configuring a voice receiving module of a voice activity detection subsystem to receive an original sound signal; configuring a feature extraction module of the voice activity detection subsystem to extract a plurality of features from the original sound signal; configuring a first determination module of the voice activity detection subsystem to execute a first classification process and determine whether or not the plurality of features match to a start-up voice; storing the plurality of extracted features in a database. In response to the first determination module determining that the plurality of features match the start-up voice, the method further includes configuring a second determination module of an acoustic event detection subsystem to execute a second classification process to determine whether or not the plurality of features match to at least one of a plurality of predetermined voices. In response to the second determination module determining that the plurality of features match at least one of the plurality predetermined voices, the method further includes configuring a function response module of the acoustic event detection subsystem to execute one of a plurality of functions corresponding to the at least one of the plurality of predetermined voices that is matched.

Therefore, the acoustic event detection system and method provided by the present disclosure can save computing usage and reduce power consumption in cases where features are extracted only once by combining feature extractions in two stages of voice detection (VAD) and acoustic event detection (AED).

In addition, when the start-up voice is determined to exist, the plurality of extracted features in the database are transferred to an identification stage instead of the original sound signal being transferred. Since memory spaces occupied by the features are usually less than the original sound signal, the acoustic event detection system and method provided by the present disclosure can further save memory usage and transmission bandwidth.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram of an acoustic event detection system according to an embodiment of the present disclosure;

FIG. 2 is a flowchart of an extraction process according to an embodiment of the present disclosure; and

FIG. 3 is a flowchart of an acoustic event detection method according to another embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

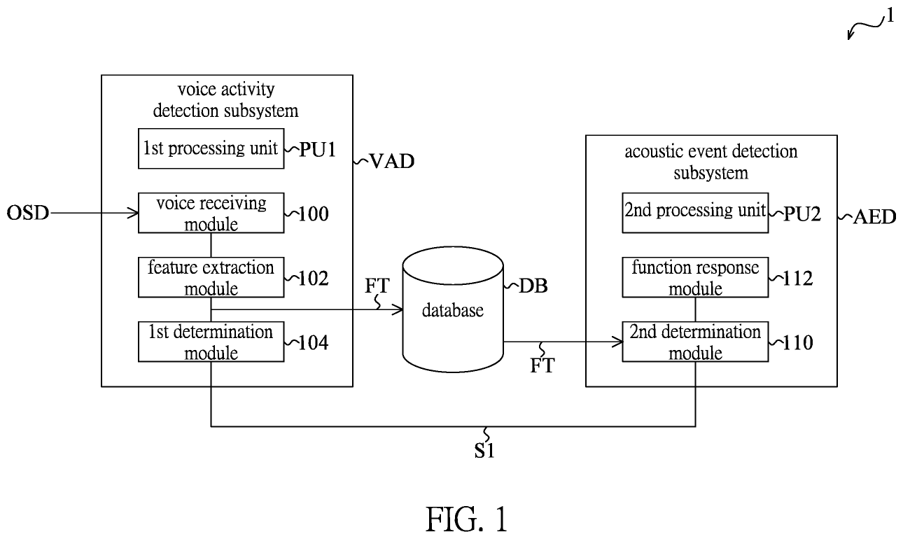

Reference is made to FIG. 1, which is an embodiment of the present disclosure that provides a sound event detection system 1, including a voice activity detection subsystem VAD, a database DB, and an acoustic event detection subsystem AED.

The database DB can be, for example, a static random access memory (SRAM), a dynamic random access memory (DRAM), a hard disk, a flash memory, or any available memory or storage device that can be used to store electronic signals or data.

The voice activity detection subsystem VAD includes a voice receiving module 100, a feature extraction module 102, and a first determination module 104. In some embodiments, the voice activity detection subsystem VAD can include a first processing unit PU1. In this embodiment, the first processing unit PU1 can be a central processing unit, a field-programmable gate array (FPGA), or a multi-purpose chip that can load programming language to perform corresponding functions, which is used to execute codes used to implement the feature extraction module 102 and the first determination module 104, and the present disclosure is not limited thereto. All modules included in the voice activity detection subsystem VAD can be implemented in software, hardware or firmware.

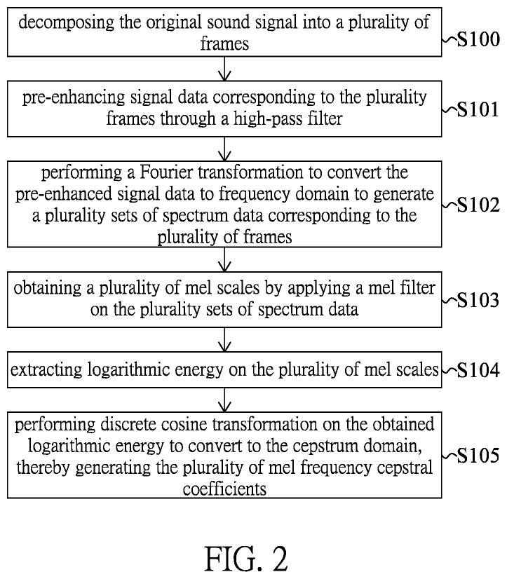

The voice receiving module 100 is configured to receive an original sound signal OSD. The voice receiving module 100 includes a microphone that can receive the original sound signal OSD, and the microphone can transmit the received original sound signal OSD to the feature extraction module 102. The feature extraction module 102 is configured to extract a plurality of features FT from the original sound signal OSD. For example, the plurality of features FT can be a plurality of Mel-Frequency Cepstral Coefficients (MFCCs). The feature extraction module 102 can extract the plurality of features FT of the original sound signal OSD through an extraction process. Reference can be further made to FIG. 2, which is a flowchart of an extraction process according to an embodiment of the present disclosure. As shown in FIG. 2, the extraction process can include the following steps:

Step S100: decomposing the original sound signal into a plurality of frames.

Step S101: pre-enhancing signal data corresponding to the plurality frames through a high-pass filter.

Step S102: performing a Fourier transformation to convert the pre-enhanced signal data to frequency domain to generate a plurality sets of spectrum data corresponding to the plurality of frames.

Step S103: obtaining a plurality of mel scales by applying a mel filter on the plurality sets of spectrum data.

Step S104: extracting logarithmic energy on the plurality of mel scales.

Step S105: performing discrete cosine transformation on the obtained logarithmic energy to convert to the cepstrum domain, thereby generating the plurality of mel frequency cepstral coefficients.

Next, reference is made back to FIG. 1, the voice activity detection subsystem VAD further includes a first determination module 104 configured to execute a first classification process to determine whether or not the plurality of features FT match to the start-up voice. It should be noted that the first classification process includes comparing the plurality sets of frequency spectrum data corresponding to the plurality of frames generated in the extraction process with frequency spectrum data of the start-up voice to determine whether or not the plurality of features match to the activation voice. Alternatively, the first classification process can also include comparing the MFCCs corresponding to the plurality of frames generated in the extraction process with MFCCs of the start-up voice to determine whether or not the plurality of features match to the start-up voice.

It should be noted that the acoustic event detection subsystem AED can always be in a sleep mode or a common power saving mode to minimize power consumption of the acoustic event detection system 1. When the first determination module 104 determines that the plurality of features FT match the start-up voice, an acoustic event detection activation signal S1 can be generated to wake up the acoustic event detection subsystem AED.

On the other hand, the aforementioned database DB can be used to store the plurality of extracted feature FT, and the plurality of features FT can include, for example, a plurality sets of spectrum data corresponding to the plurality of frames and MFCCs obtained in the extraction process. In addition, data related to the start-up voice, such as spectrum data and MFCCs thereof, can also be stored in the database DB, but the present disclosure is not limited thereto. The voice activity detection subsystem VAD can also have a built-in memory for saving the above data.

Further, the acoustic event detection subsystem AED can include a second determination module 110 and a function response module 112. In some embodiments, the sound event detection subsystem AED can include a second processing unit PU2. In this embodiment, the second processing unit PU2 can be a central processing unit, a field-programmable gate array (FPGA), or a multi-purpose chip that can load programming language to perform corresponding functions, which is used to execute codes used to implement the second determination module 110 and the function response module 112, and the present disclosure is not limited thereto. All modules included in the acoustic event detection subsystem AED can be implemented in software, hardware or firmware, and the first processing unit PU1 and the second processing unit PU2 can be implemented by a single one of the above-mentioned hardware, instead of being divided into two processing units.

In response to the first determination module 104 determining that the plurality of features FT match the start-up voice, or in response to an activation of the acoustic event detection subsystem AED by receiving the acoustic event detection activation signal S1, the second determination module 110 is configured to execute a second classification process to determine whether or not the plurality of features FT match to at least one of a plurality of predetermined voices. The data related to the plurality of predetermined voices can be pre-defined by a user and built into the acoustic event detection subsystem AED. For example, the data can include frequency spectrum and MFCCs extracted from the plurality of predetermined voices by using a similar extraction process. Alternatively, the data can be stored in the database DB.

In detail, the second classification process includes identifying the plurality of features through a trained machine learning model to determine whether or not the plurality of features match to at least one of the predetermined voices. These features, for example, a plurality of MFCCs extracted from the original sound signal OSD, can be used as input feature vectors and be input into a trained machine learning model, for example, a neural network model.

The so-called trained machine learning model can be generated by dividing data related to preprocessed multiple predetermined voices into a training data set and a validation data set according to an appropriate ratio, and using the training data set to train the machine learning model. The validation data set is input into the machine learning model, which is then assessed whether it reaches an expected accuracy. If the machine learning model has not yet reached the expected accuracy, hyperparameter adjustments are made to the machine learning model, and the machine learning model is continuously trained with the training data set until the machine learning model passes a performance test. The machine learning model that passes the performance test will then be used as the trained machine learning model.

Next, reference is made back to FIG. 1 again. The acoustic event detection subsystem AED further includes a function response module 112, which executes, in response to the second determination module 110 determining that the plurality of features FT match at least one of the plurality predetermined voices, one of a plurality of functions corresponding to the at least one of the predetermined voices that is matched.

Therefore, the acoustic event detection system and method provided by the present disclosure can save computing usage and reduce power consumption in cases where features are extracted only once by combining feature extractions in two stages of voice detection (VAD) and acoustic event detection (AED). In addition, when the start-up voice is determined to exist, the plurality of extracted features in the database are transferred to an identification stage instead of the original sound signal is transferred. Since memory spaces occupied by the features are usually less than the original sound signal, memory usage and transmission bandwidth can be further saved.

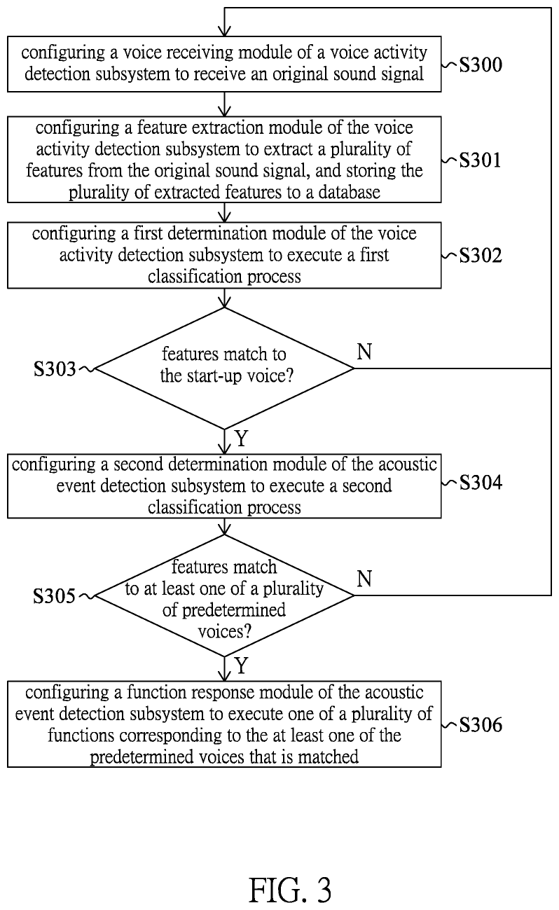

FIG. 3 is a flowchart of an acoustic event detection method according to another embodiment of the present disclosure. Reference is made to FIG. 3, which is another embodiment of the present disclosure that provides an acoustic event detection method, and at least includes the following steps:

Step S300: configuring a voice receiving module of a voice activity detection subsystem to receive an original sound signal.

Step S301: configuring a feature extraction module of the voice activity detection subsystem to extract a plurality of features from the original sound signal, and storing the plurality of extracted features to a database.

Step S302: configuring a first determination module of the voice activity detection subsystem to execute a first classification process.

Step S303: configuring the first determination module to determine whether or not the plurality of features match to the start-up voice. If the first determination module determines that the plurality of features match the start-up voice, the method proceeds to step S304. If the second determination module determines that the plurality of features do not match to the at least one of the plurality of predetermined voices, the method proceeds back to step S300.

In response to the first determination module determining that the plurality of features match the start-up voice, the method proceeds to step S304: configuring a second determination module of the acoustic event detection subsystem to execute a second classification process.

Step S305: configuring a second determination module to determine whether the plurality of features match to at least one of a plurality of predetermined voices. If the second determination module determines that the plurality of features match the at least one of the plurality of predetermined voices, the method proceeds to step S306. If the second determination module determines that the plurality of features do not match to the at least one of the plurality of predetermined voices, the method proceeds back to step S300.

In response to the second determination module determining that the plurality of features match at least one of the plurality predetermined voices, the method proceeds to step S306: configuring a function response module of the acoustic event detection subsystem to execute one of a plurality of functions corresponding to the at least one of the predetermined voices that is matched.

Specific implementations of each step and equivalent changes thereof have been described in detail in the foregoing embodiments, and thus repeated descriptions are omitted hereinafter.

In conclusion, the acoustic event detection system and method provided by the present disclosure can save computing usage and reduce power consumption in cases where features are extracted only once by combining feature extractions in two stages of voice detection (VAD) and acoustic event detection (AED).

In addition, when the start-up voice is determined to exist, the plurality of extracted features in the database are transferred to an identification stage instead of the original sound signal being transferred. Since memory spaces occupied by the features are usually less than the original sound signal, the acoustic event detection system and method provided by the present disclosure can further save memory usage and transmission bandwidth.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An acoustic event detection system, comprising:
a voice activity detection subsystem, including:
a voice receiving module configured to receive an original sound signal;
a feature extraction module configured to extract a plurality of features from the original sound signal; and
a first determination module configured to execute a first classification process to determine whether or not the plurality of features match to a start-up voice;
a database configured to store the plurality of extracted features; and
an acoustic event detection subsystem, including:
a second determination module configured to, in response to the first determination module determining that the plurality of features match the start-up voice, execute a second classification process to determine whether or not the plurality of features match to at least one of a plurality of predetermined voices; and
a function response module configured to, in response to the second determination module determining that the plurality of features match at least one of the plurality of predetermined voices, execute one of a plurality of functions corresponding to the at least one of the plurality of predetermined voices that is matched.

2. The acoustic event detection system according to claim 1, wherein the plurality of features are a plurality of Mel-Frequency Cepstral Coefficients (MFCCs).

3. The acoustic event detection system according to claim 2, wherein the feature extraction module extracts the plurality of features of the original sound signal through an extraction process, and the extraction process includes:
decomposing the original sound signal into a plurality of frames;
pre-enhancing signal data corresponding to the plurality of frames through a high-pass filter;
performing a Fourier transformation to convert the pre-enhanced signal data to a frequency domain to generate a plurality of sets of spectrum data corresponding to the plurality of frames;
obtaining a plurality of mel scales by applying a mel filter on the plurality of sets of spectrum data;
extracting logarithmic energy on the plurality of mel scales; and
performing a discrete cosine transformation on the obtained logarithmic energy to convert to a cepstrum domain, so as to generate the plurality of Mel-Frequency Cepstral Coefficients.

4. The acoustic event detection system according to claim 3, wherein the first classification process includes comparing the plurality of sets of spectrum data with spectrum data of the start-up voice to determine whether the plurality of features match to the start-up voice.

5. The acoustic event detection system according to claim 1, wherein the second classification process includes identifying the plurality of features through a trained machine learning model to determine whether the plurality of features match to at least one of the plurality of predetermined voices.

6. An acoustic event detection method, comprising:
configuring a voice receiving module of a voice activity detection subsystem to receive an original sound signal;
configuring a feature extraction module of the voice activity detection subsystem to extract a plurality of features from the original sound signal;
configuring a first determination module of the voice activity detection subsystem to execute a first classification process and determine whether or not the plurality of features match to a start-up voice; and
storing the plurality of extracted features in a database;
wherein in response to the first determination module determining that the plurality of features match the start-up voice, configuring a second determination module of an acoustic event detection subsystem to execute a second classification process to determine whether or not the plurality of features match to at least one of a plurality of predetermined voices;
wherein in response to the second determination module determining that the plurality of features match at least one of the plurality of predetermined voices, configuring a function response module of the acoustic event detection subsystem to execute one of a plurality of functions corresponding to the at least one of the plurality of predetermined voices that is matched.

7. The acoustic event detection method according to claim 6, wherein the plurality of features are a plurality of Mel-Frequency Cepstral Coefficients (MFCCs).

8. The acoustic event detection method according to claim 7, wherein the feature extraction module extracts the plurality of features of the original sound signal through an extraction process, and the extraction process includes:
decomposing the original sound signal into a plurality of frames;
pre-enhancing signal data corresponding to the plurality of frames through a high-pass filter;
performing a Fourier transformation to convert the pre-enhanced signal data to a frequency domain to generate a plurality of sets of spectrum data corresponding to the plurality of frames;
obtaining a plurality of mel scales by applying a mel filter on the plurality of sets of spectrum data;
extracting a logarithmic energy on the plurality of mel scales; and
performing a discrete cosine transformation on the obtained logarithmic energy to convert to a cepstrum domain, so as to generate the plurality of Mel-Frequency Cepstral Coefficients.

9. The acoustic event detection method according to claim 8, wherein the first classification process includes comparing the plurality of sets of spectrum data with spectrum data of the start-up voice to determine whether the plurality of features match to the start-up voice.

10. The acoustic event detection method according to claim 6, wherein the second classification process includes identifying the plurality of features through a trained machine learning model to determine whether the plurality of features match to at least one of the plurality of predetermined voices.
